(19) United States
(12) Patent Application Publication
(10) Pub. No.: US 2014/0114486 A1
(43) Pub. Date: Apr. 24, 2014

(54) SELF ADJUSTING SUPPORT SYSTEM

(71) Applicant: Varatharaj Ponnuhamy, Coimbatore (IN)

(72) Inventor: Varatharaj Ponnuhamy, Coimbatore (IN)

(21) Appl. No.: 14/124,707

(22) PCT Filed: Jun. 22, 2012
(86) PCT No.: PCT/IB2012/053162

§ 371 Date: Dec. 7, 2013

(30) Foreign Application Priority Data
Jun. 24, 2011 (IN) 2131/CHE/2011

(51) Int. Cl. G05B 13/02

(52) U.S. Cl. CPC G05B 13/02
USPC 700/275

(57) ABSTRACT

In view of the foregoing, an embodiment herein provides an automated self adjusting support system, for human resting appliances like chair, seat, mattress, bed and shoe. Accordingly, the system includes plurality of pillars kept closely together to form surface profile of said appliance for comfortable resting of the human body part, wherein the pillar includes an outer casing, an inner casing, force sensor unit, gear and thread mechanism, and an axial motor, a controller unit connected to the sensors and the motors, which is capable of receiving force output from the sensors and rotate the motors in any direction at desired/variable speed to adjust the height of said pillars, and a processor unit suitably programmed to map the human body part being rested in each area of the pillars, estimate the strength of said area and apply the force proportionate to the strength/hardness in the area.

### FIELD OF INVENTION

The embodiments herein generally relate to human body supporting systems, more particularly to a self adjusting supporting system used in various human support appliances like chair, seat, mattresses, bed and even shoes. The system is designed and configured with multiple small size pillars placed close to each other which are height adjustable, together forming a resultant top surface profile as per the body shape and provide support at each area proportionate to the strength of body area for better comfort, and further keep changing that profile time to time for better blood flow, wherein the force on each pillar is measured and height of each pillar is adjusted by commands issued by processor units.

### BACKGROUND OF THE INVENTION

In today's world, there is a growing demand for ergonomically designed furniture to provide the necessary comfort and support to the human body. Now days, more people are having sitting work and people are busy at work and not having time to move around. Whereas human body needs continuous change in posture for better blood flow. We can observe that the people are keep switching the posture while sitting for long time. And it is worse while driving or flying for a long time not being able to switch posture freely. After spending the whole day busily working one goes to sleep with tiredness that too for a shorter time then naturally needed, one has no energy to switch posture sufficiently while sleeping, and causing body pain while waking up due to partially blocked blood flow at night. Similarly there are industrial worker who keep on standing and working for long time facing the similar blood flow blockage problem at the bottom of the feet.

While sitting or sleeping for long time, one has to keep shifting or moving because, the body surface is pressed continuously against the resting appliance causing blood veins being pressed partially or fully blocking the blood flow that in turn can cause strain and damage to the skin and muscles. In the case of elderly people, sick people, hospitalized patients and coma patients the situation is worst because they are unable to move or switch posture and making continuous pressing of muscles over the seat or bed, causing the blood flow to slow down, making the contacting skin weaker, that is being major reason for sores and bed ulcers.

To combat these problems we are really in need of a new approach. But presently available resting appliance like chair/seat/bed/mattress does not consider the strength of resting body at each area at the time when the person is rested on it. Appliance with foam or spring would apply force on each area depending how much it is being pressed there, that would always press harder where it is pressed down deeper. Another set of appliance with air or net would apply same force all over. Fixed shape appliance cannot perfectly match to resting body. But best comfort would be possible only when the resting appliance consider the difference of strength and apply different force at each area proportionate to the strength of the respective body area.

In the prior art, there have been a lot of devices designed in order to help a human body maintain a correct posture. Seating devices wherein the user can adjust the height of the seat as well as the backrest of the seat are available commercially. Besides being comfortable when seated for long hours, they also provide back cushioning or perforations in the cushioning that allows temperature-reducing air circulation. The commercially available ergonomically designed chair allows one to choose the degree of recline and allows height adjustment also. However, in these seating devices the user himself have to adjust the seat and the same is not automatic. Also, though they provide correct postures, many of them do not provide a means of better blood circulation when this ergonomically designed furniture is used. Existing chairs do not address the gradual blood flow blockage due to constant pressing of muscles over the seat for long hours; people have to all the time keep moving readjusting themselves to overcome this issue.

There are also patents wherein devices have been designed using airbags and push rods. U.S. Pat. No. 4,989,283 disclosed a body support which had a plurality of air cells. The position of the user would be determined with the help of sensors that would transmit the information to a multiplexer which in turn transmits it to a micro-processor that controls the operation of the valves by inflating or deflating the air valves. In this device, a user had to be placed in various positions on the mattress and the height distance from each of the sensors is stored in the control system. One of the disadvantages of this equipment was that a user had to input information to determine his parameters into the control system when he uses it for the first time. Also, these data need to be inputted by an operator.

US 2011/0006568 A1 discloses one such device wherein efforts have been made to support the human spine while seating. In this application, there are push rods that sense the height that a seat has to inflate and deflate. However, this invention uses mobilizing devices in each height sensor. Each airbag is connected to air pipes and has control switches. The entire arrangement of each airbag connected with control switches and air pipes, the mobilizing devices that are connected to the height rods which are again connected to the airbags makes the device heavy as well as expensive.

Many of the prior art devices that were ergonomically designed to support human posture consisted of support mechanism for either beds or seats only. An ergonomically designed support system which can support any part of the human body, for example, the spine, the neck, the limbs or the feet has not been anticipated yet.

Therefore, there exists a need in the art to provide for an ergonomically designed self support system that can support any part of the body allowing different force at each location by automatically changing its resting surface profile which should not only provide comfortable resting but also should improve blood circulation. Further it should change its surface profile such that part of the resting muscle is relieved from pressure or pressed harder letting the easy blood flow.

### OBJECTS OF THE INVENTION

A main object of the present invention is to provide an ergonomically designed support system that can support any body part.

Another object of the present invention is to provide a supporting system that can be used in all kinds of human-needed ergonomic appliances.

Yet another object of this invention is to support at each small area of the body by just pressing as much pressure it can take.

Yet another object of the present invention is to solve the fatigue problem that is experienced when a person's posture does not change for a long time.

Yet another object is to provide a system that not only improves blood circulation to reduce numbness and sores by varying its profile but also changes its profile at predetermined times so that the position of the end user changes.

Yet another object is to relieve part of the area time to time and switching the relieving part all over making it comfortable and healthy for long hours.

The other objects and advantages of the present invention will be apparent from the following description when read in conjunction with the accompanying drawings which are incorporated for illustration of preferred embodiments of the present invention and are not intended to limit the scope thereof.

### SUMMARY OF THE INVENTION

In view of the foregoing, an embodiment herein provides an automated self adjusting support system, wherein the system includes plurality of height adjusting pillars, plurality of motor and gearing arrangements placed inside the pillars to adjust the height, plurality of force sensors using springs and coils to measure force at each pillar, a controller unit for controlling the height of the pillars based on the height and force measured under each pillars, wherein the motor can rotate and adjust the height of the designated pillars based on the command received from the processor unit, wherein adjusting the height of each pillars the top surface of all pillars together forms the desired profile.

According to an embodiment, the self adjusting supporting system is designed by forming the surface profile as needed as if a custom surface profile can be created as-and-when the person is rested. Human body has different strength and hardness at different area of each part on the outer surface. When the human body comes in contact with the support system, the self adjusting supporting system can measure the force and estimate the strength of each small area, sharing the weight of the whole body proportionally at each small area, by providing as much pressure as it can take at each location; thereby enabling to provide the best comfort. Further, each area of the resting surface of the body can be relieved time to time alternating the relieving area for better blood flow. Incorrect postures can introduce sickness for the bone and muscles, so the present support system can also visualize the posture and change its top surface for a better posture. Additionally the present invention also provides simple slow massaging to improve the blood flow. It also provides various other interactive features.

In an embodiment, to provide better shape, the profile of the support appliance is created by plurality of height-adjusting pillars. The size and number of pillars used in the appliance are determined and selected based on the type and size of the appliances. Further, the pillars are equipped with force sensors to measure the force at each pillar, and the force sensors are connected to the controller unit. The force change due to human body weight at each pillars are monitored by the controller unit, the overlying body and its posture is visualized by the controller unit and the pillars heights are varied to form a desired top surface profile. The controller unit can command several pillars simultaneously to adjust the height of the pillars and can lock the height-position of the pillars based on the command received from controller unit.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a general profile of height-adjustable pillars closely placed each other, according to an embodiment;

FIG. 2A and FIG. 2B illustrate side view and internal view of the height adjustable pillar according to an embodiment;

FIG. 3 illustrates force sensor mechanism inside the pillar, according to an embodiment;

FIGS. 4A and 4B illustrate thread and gear arrangement that connects the motor to the moving part of the pillar to actuate according to an embodiment;

FIGS. 5A and 5B illustrate the external and interview view of a motor according to an embodiment;

FIG. 6 illustrates surface profile of a mattress according to an embodiment;

FIG. 7 illustrates top view of triangular shape of pillars, according to an embodiment;

FIG. 8 illustrates surface profile of a mattress along with the pillars of triangular shape are used, according to another embodiment;

FIG. 9 illustrates the view of pillars with hexagonal shape of pillars, according to an embodiment;

FIG. 10 illustrates the use of support plate surrounded on top of each pillars, according to an embodiment;

FIGS. 11A and 11B illustrate the variation of pillar height changes based on the end user sits over on it, according to an embodiment;

FIGS. 12A and 12B illustrate the use of profile on the base plate, according to an embodiment;

FIGS. 13A and 13B illustrate the use of flexible net and flexible sheet on top of the pillars, according to an embodiment;

FIGS. 14A and 14B illustrate pressure relieving method, according to an embodiment; and

FIGS. 15A and 15B illustrate pressurization method over human body, according to an embodiment.

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

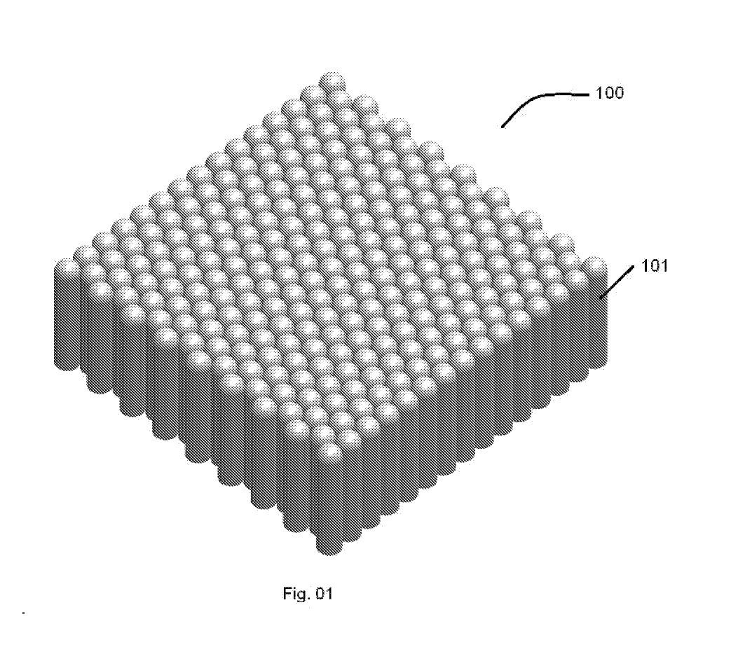

As mention, there is a need in the art to provide for an ergonomically designed self support system that can support any part of the body, which not only provides a comfortable surface profile but also changes its surface to relieve or press different area to improve blood circulation. The embodiments herein achieve this by providing an automated self support system with multiple height-adjustable pillars, a controller unit and a processing unit (CPU). Referring now to the drawings, and more particularly to FIGS. 1 through 15B, where similar reference characters denote corresponding features consistently throughout the figures, there are shown preferred embodiments.

It is to be noted that even though the description of the invention has been explained using a mattress, it should, in no manner, be construed to limit the scope of the invention. The system and methods of the invention can be applied to any types of human body supporting appliances.

FIG. 1 illustrates a general view 100 of the pillars of the support system, according to an embodiment. The pillars 101 are closely placed to each other such that the space between any two pillars is minimal. Further, the top of the pillar may be rounded for being able to create smoother profile, according to an embodiment. The size and number of pillars can vary, depending on the type of appliances. For example, a chair might use hundreds of pillars whereas a mattress might use thousands of pillars. The shape of the pillars can include but not limited to round, triangular, hexagonal or square shaped cross sections. There may be a base plate 1102 to enclose the space from below/behind.

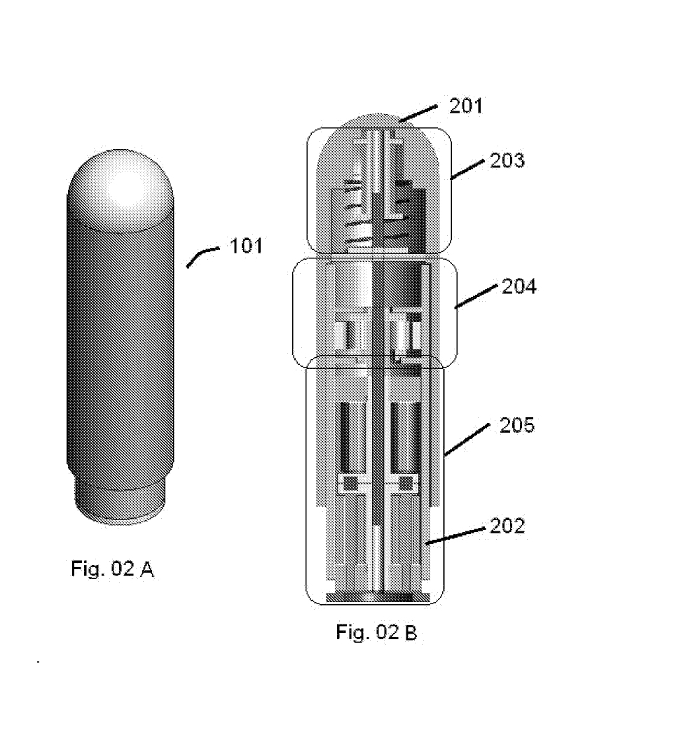

FIG. 2A illustrates an individual pillar 101 and FIG. 2A illustrates various parts inside the pillar 101, according to an embodiment. In accordance with an embodiment of the present invention, the pillar 101 can include outer casing 201, inner casing 202, force sensor unit 203, gear and thread mechanism 204, and motor 205.

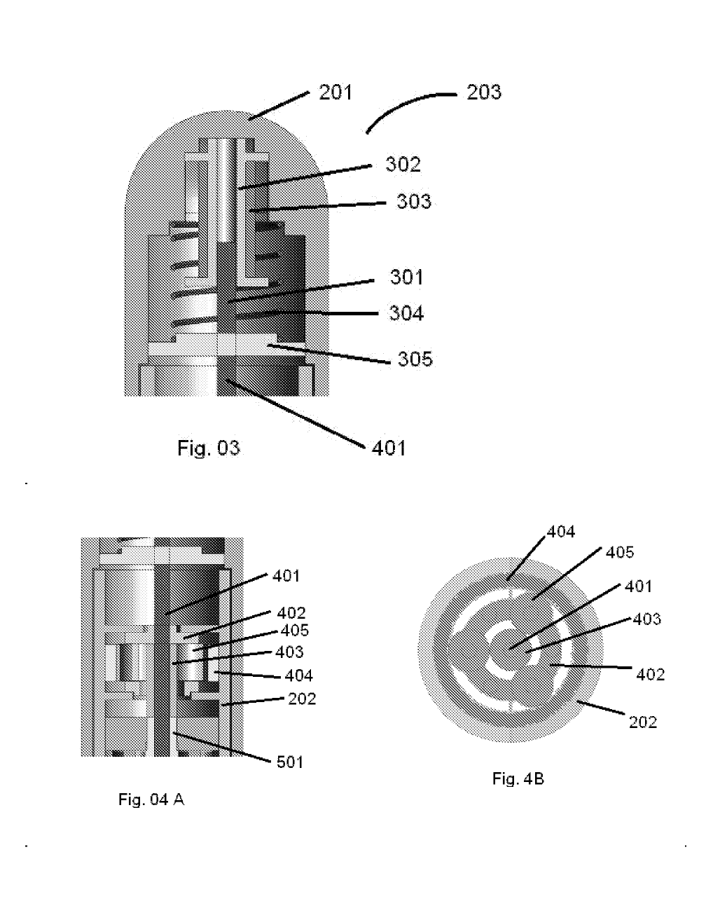

FIG. 3A illustrates force sensor unit 203, according to an embodiment. The force sensor unit 203 comprises of a spring 304, a pin 301, a bobbin 302 and coils 303. The pin 301 can be made of metal, preferably a ferrous part and the coil 303 can be conductive and may consists of primary and secondary coil. The bobbin 302 and coil 303 can be fitted in the outer case 201. The outer case 201 may rest on the spring 304, the spring may rest on the disk 305, and the disk 305 may be fixed to the pin 301. When the outer casing is pressed down, depending on the force, it can move down by predetermined distance that is proportional to the force. So the pin 301 can enter that much distance inside the coil 303.

According to an embodiment, input current pulse can be applied through the primary coil and the current pulse returned through the secondary coil can be measured. Further, voltage can be raised in the primary coil and kept constant for a short duration in milliseconds. At the same time, rising and dropping of the voltage can be found in the secondary coil. Depending on the pin 301 movement distance inside the coil, the duration of the rising and dropping of the voltage in the secondary coil can vary. Particularly, when the pin is away from the coil the duration is found minimum, and when the pin is fully inside the coil the duration is found maximum. In an embodiment, by measuring the duration of the current in the secondary coil, the distance/position of the pin inside the coil can be calculated. The distance of the pin movement is substantially equal to the distance of the spring compressed, which is proportional to the force applied on the spring. Therefore, the force on the spring can be calculated based on the duration of the current pulse. The force on the outer casing 201 may transferred to the spring 304, and thereafter the force on the spring 304 may transferred to the disk 305. Further the lower end of disk 305 may be connected to the thread rod 401.

FIGS. 4A and 4B illustrate the gear and thread mechanism, according to an embodiment. The thread rod 401 that supports the spring above can be extended down with a long threaded portion. The thread of the thread rod 401 can be engaged in the threaded hole of the planetary disk 402. The planetary disk 402 can be fitted with the inner casing 202 such a way that it can rotate but cannot move up/down. The planetary disk 402 can have few small rods on which multiple planetary gears 405 are fitted. The planetary gears 405 can be engaged in the inside with the gear 403. Further, the gear 403 can be connected with the motor shaft 501. The outer gear 404 can have gear teeth in its inner walls. The planetary gears 405 can be engaged in the outside with the gear teeth of outer gear 404. This arrangement works in such a way that when the motor shaft 501 rotates many rotations the planetary disk 402 rotates fewer rotations that produces higher torque in the planetary disk 40, according to an embodiment. Since planetary disk 402 is engaged with the thread rod 401, and the thread rod 401 can move up or down when the planetary disk 402 rotates in both directions.

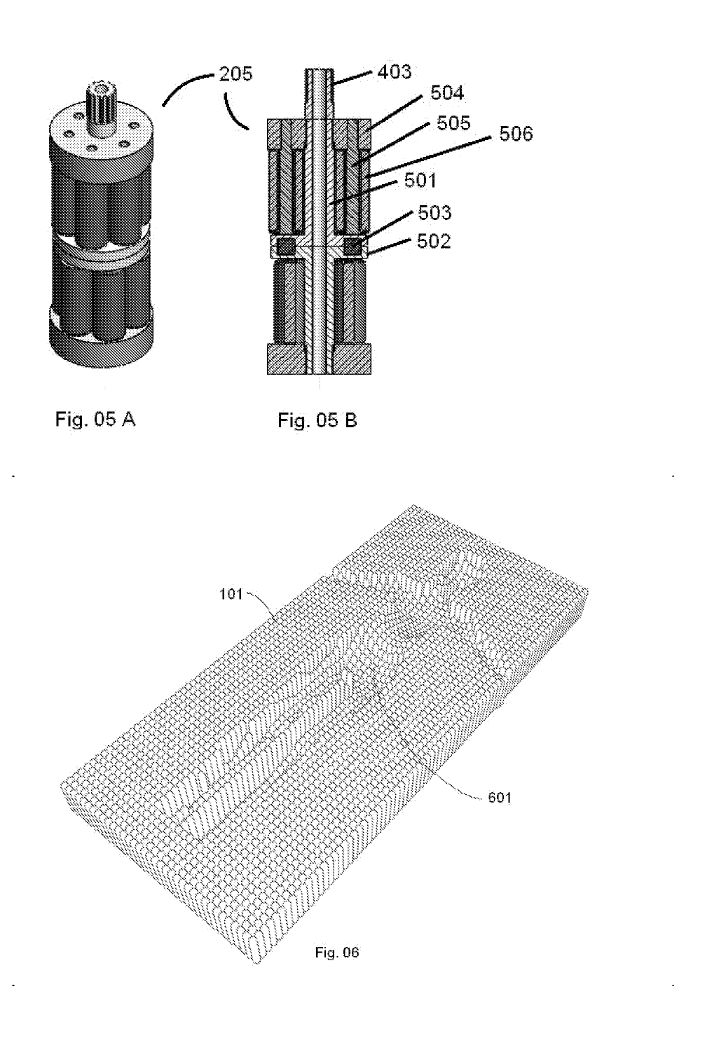

FIG. 5A, 5B illustrate internal and external view an axial motor 205, according to an embodiment. The axial motor 205 can be fitted with in the inner casing 202. Further, the axial motor 205 can be used in the pillar, which can able to produce high torque within the small space available. And the motor may have center shaft 501 that can be extended outside and can engage with a gear 403 to engage with the above planetary gear 405. The center shaft 501 can be supported on both ends by the stator disks 504. The shaft 501 can be made hollow in the middle to allow the thread rod 401 to pass through the center, to specially help reduce the total length of pillar 101. On the middle of the shaft 501, a rotor 502 can be fixed with set of magnets 503, which can be fitted in a circular manner. On the stator disk 504, set of electromagnetic pins 505 together with a coil 506 can be fitter in a circular manner. In the motor, the upper set of coils and lower set of coils can be kept with angular shift to help rotate the motor in both directions. Further, the motor 205 can rotate the shaft 501 in both the directions at any desired speed and it can also stop when needed by supplying variable frequency electric current through the coils. The circular angular shift of both side coils and the phase shift of the both electric supply can help drive/change the direction of rotation. Additionally, the frequency of the electric wave can help change the speed of rotation.

According to an embodiment, the system includes a controller unit [not shown] which is an electronic circuit powered by a power supply [not shown]. The controller unit can be connected to each motor and force sensor unit. Further, the controller unit can be connected to the force sensor to measure the force on each pillar. Additionally, the system is provided with a processing unit [not shown] which can command controller unit through wired or wireless communication. According to an embodiment, suitably programmed software is provided to run in the processing unit.

According to an embodiment, the controller unit and the suitably programmed software in the processing unit are configured such that on receiving command from the processing unit, the controller unit can pass the current to the motor and rotate it in any direction at desired/variable speed to adjust the height of the pillar as needed. The controller unit can choose one or more motors and run them simultaneously as required. The controller unit can also be connected to the coil of the sensor unit to pass the supply and measure the return current to measure the force. The controller unit can choose one or more pillars and measure the force on them.

According to an embodiment, the processing unit can have the complete force map of the whole resting area by measuring the force on each pillar. It can also remember the height information of all the pillars. This way it can predict the exact shape of the resting body. The software can be suitably programmed to properly adjust the heights of each pillar to match the top surface profile match the resting body and in such a way that it can apply uniform force in all the pillars, and the shape map of the resting body can be visualized inside the processing unit, and the strength of each area of the human body is estimated and different force is applied on each pillar proportionate to the body area.

The profile 601 of a mattress when an end user sleeps on surface of appliance, pillars of hexagonal cross-section is illustrated in FIG. 6, according to an embodiment.

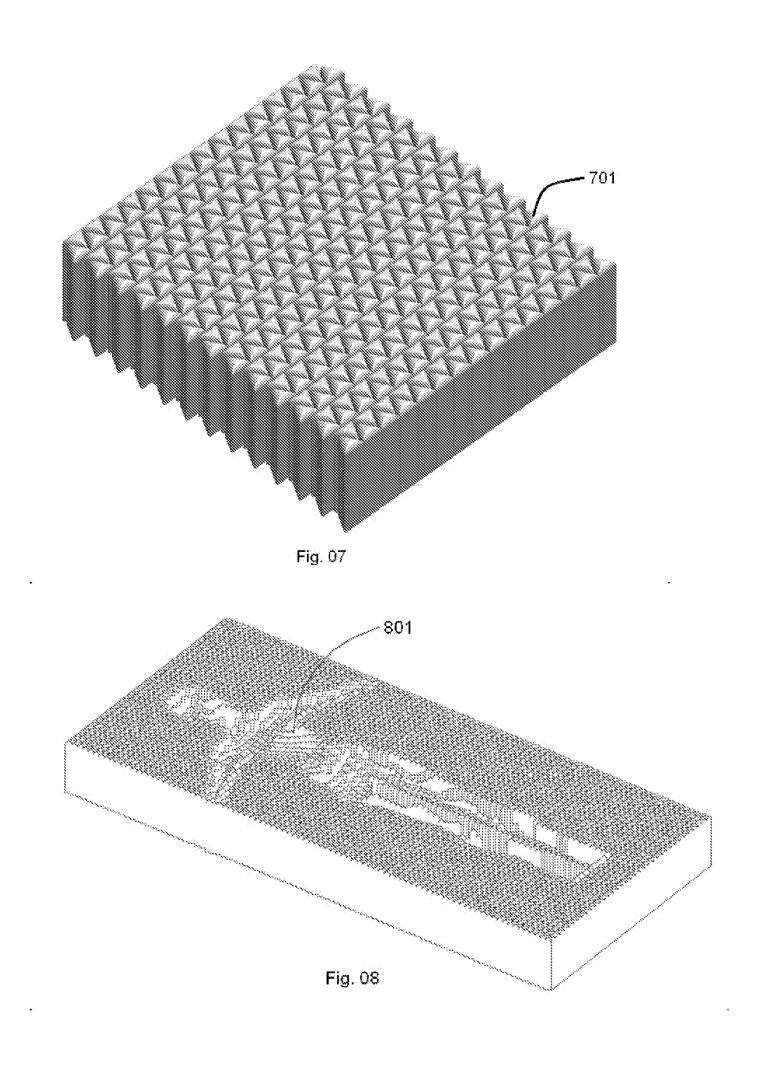

In another embodiment, to provide closely packed pillars, the pillars may have a triangular cross-section. The top profile of a segment of closely packed pillars having triangular cross-section 701 is illustrated in FIG. 7. When an end user sleeps on a mattress build with pillars of triangular cross-sections 701, the profile 801 created is illustrated in FIG. 8, according to an embodiment.

In yet another embodiment, the pillars may have square cross-sections. Therefore, the pillars may be of variable cross-section. The main aim is to provide closely packed pillars.

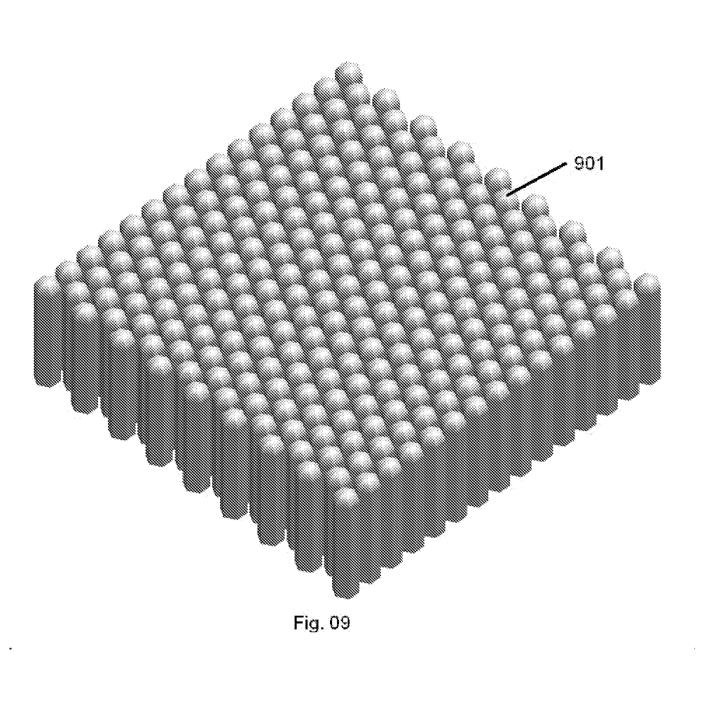

In an embodiment, the pillars 101 may have hexagonal cross-section 902 as illustrated in FIG. 9.

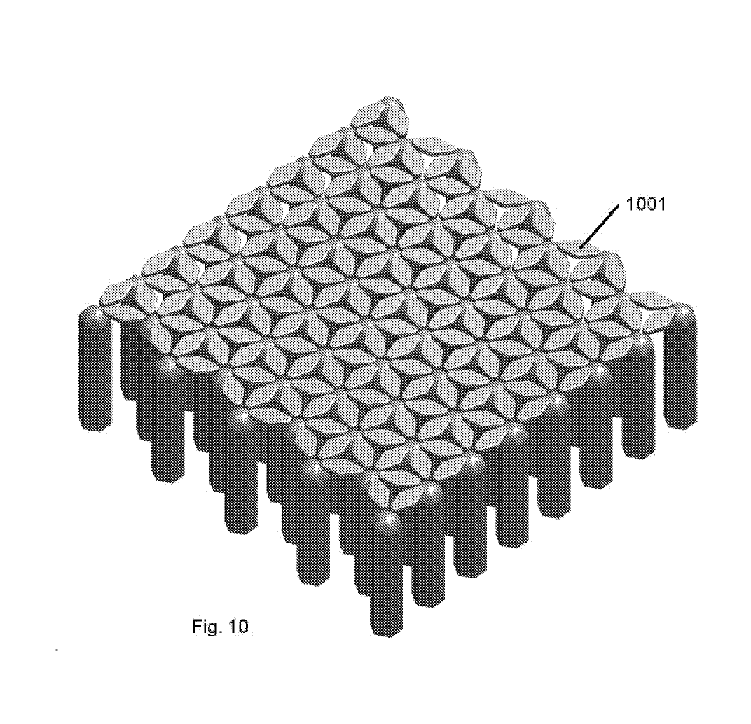

FIG. 10 illustrates the use of additional cross plates to make the whole chair or mattress economic, according to an embodiment. We can leave space between the pillars and connect the top of all pillars with interlinking cross plates 1001 to cover and support at the free space between pillars.

FIGS. 11A and 11B illustrate the variation of pillar height changes based on the end user sits over on it, according to an embodiment. Accordingly, the heights of pillars 101 can be dynamically adjusted to match the shape of the resting body 1101 forming the top surface profile as needed for the resting body.

Since the visualized shape of the body is done in the processing unit, it can move down at specific locations to provide relief to specific parts of the resting body.

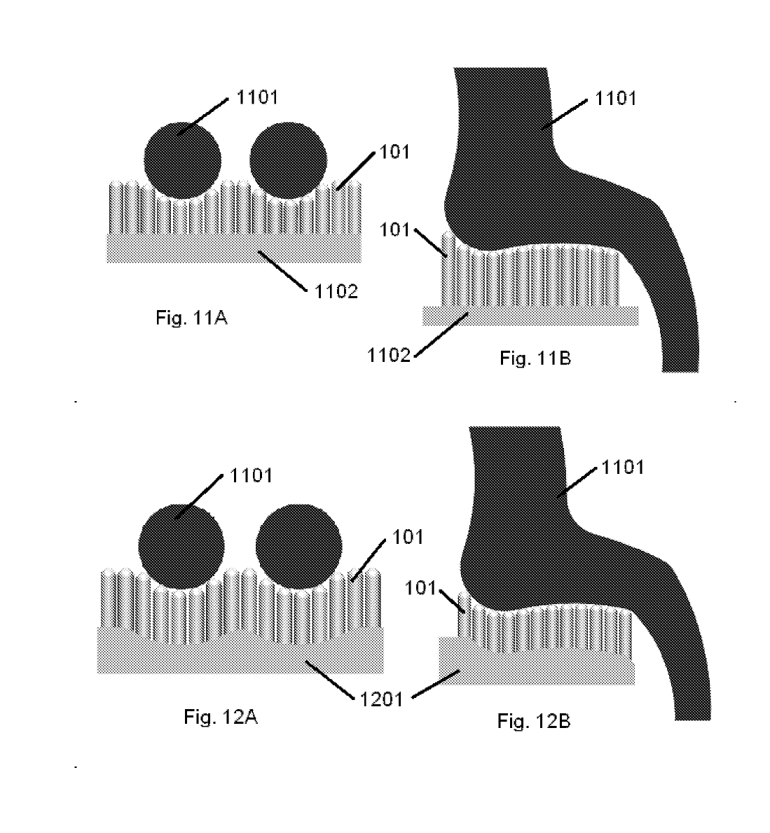

FIGS. 12A and 12B illustrate the use of profile on the base plate, according to an embodiment. Accordingly, the shape of the bottom base plate can also have some profile to reduce the stroke length or adjustment needed by the pillars to create the top surface profile.

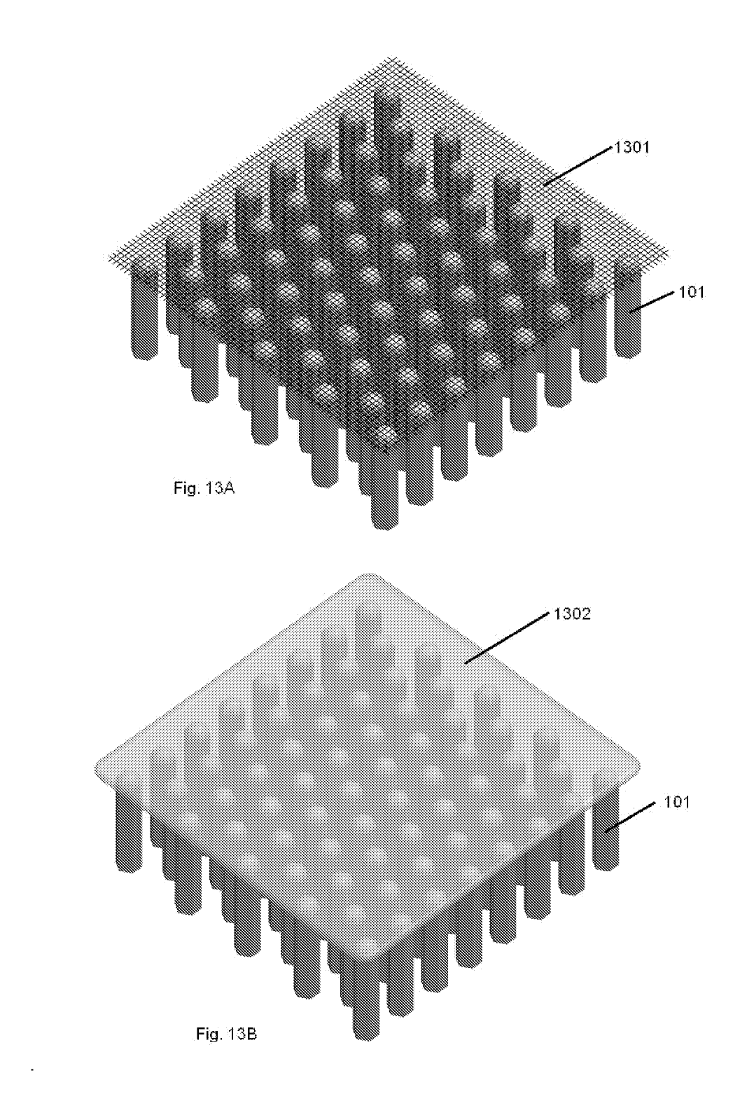

FIG. 13A illustrates a flexible net 1301 provided on top of the pillars which can enable to leave space between the pillars making it economic, according to an embodiment. FIG. 13B illustrates a flexible sheet 1302 provided on top of the pillars which can enable to leave space between the pillars making it economic, according to an embodiment.

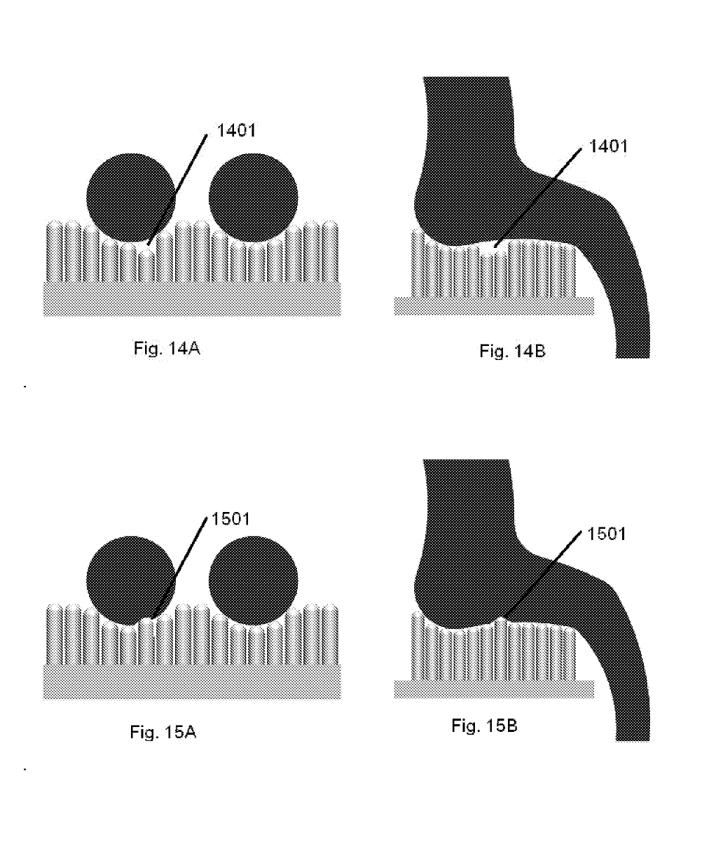

FIGS. 14A and 14B illustrate pressure relieving method, according to an embodiment. Accordingly, when an end user rests over on supporting appliance for a long time, the present system can choose different area at predetermined duration and further can move down 1401 the pillars to relieve different area at predetermined duration to provide comfort and better blood flow to the resting body. Further the pillars can move up 1501 and press the human body like massaging to improve the blood flow in that muscles as illustrated in the FIGS. 15A and 15B.

In an embodiment, the controller unit can command pillar 101 to move in such a way to make small variations on the top surface profile, for example, releasing the force at one area at one time, and another area at another time, for better blood flow.

When the present self-adjusting support system is used on a chair and the seating surface of the chair can be made at different location and different inclination such a way that the desired posture (like forward lock posture or backward lock posture) can be created.

In an embodiment, if an end user desires to keep his posture in a certain position, the present system can enable the same by locking the desired surface profile.

While sleeping, many a times, a person does not change positions which results in body pain and fatigue. To overcome this, in an embodiment of the present invention, the top profile of supporting system can be programmed to be formed to another shape such that a person's body can be forced to switch to a different posture after a pre-determined time of resting in the same position.

In another embodiment, a pre-determined surface profile can be kept ready for the end user to help him/her to take the ergonomic posture with ease.

In yet another embodiment, there can be specific movements provided at a pre-determined time to make a person realize the time. For example, specific movements in pillars such as vibration can be made for a wake-up call, or reminder for a meeting.

In an embodiment of the present invention, a slow massage for better blood circulation and relaxation can be provided by the present system.

In an advantageous embodiment, whenever a body part of an end user is weak or injured, the surface profile is made in such a way that the injured or weak body part is not pressed hard.

In an embodiment, the use of a pillow can be mitigated as the surface profile can be arranged in a way that provides the shape of a pillow. Also, the support system makes sure that the head is aligned properly with the rest of the body.

In another advantageous embodiment, the end user can use multiple gestures to customize the surface profile. For example, tapping on a certain area, pressure movements in certain directions or rubbing with certain finger movements to communicate to the controller unit to achieve the desired surface profile.

Another advantage of the present invention is to safeguard the injured part or weak part of the human body, an end user can define which part of the human body part should not be pressed, and the present supporting system can intelligently consider the input, and can give relief to that part by reducing the height of the pillars in that area.

Further, the end user can define which part of the human body can be applied with higher force and accordingly the system can recognize the input and can increase the height of the pillars in that area and exert additional force in that area to relieve the other area.

Yet another advantage is that the chair can be set to provide forward lock or backward lock posture and accordingly the system can create the top surface profile to force the human body to sit in the desired posture.

Further advantage of the present invention is that by logging the previously rested posture of end user and timings, the resting appliance can form and keep a predefined top profile to a desired shape ready for the next time use.

Additionally, while sleeping on mattress, the present system can provide necessary air gap and additional relief to save the important organs such as nose, eyes, ear etc.,

Further, the present system can provide customized profile as set by the end user.

Accordingly, the present invention provides resting appliance like seat/bed/mattress/shoe/chair being able to exert different force/pressure at different area of the resting body depending on the strength and hardness of the respective body surface; that is, by sensing the force/pressure map of the whole resting surface and visualizing the body shape in a processor using a software program and guessing the human body part being rested in each small area and estimating the strength of each area and applying the force proportionate to the strength/hardness in that area.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. An automated self adjusting support system for human resting appliances, wherein the system comprises of
plurality of pillars kept closely together to form top surface profile of said appliance for comfortable resting of the human body part, wherein said pillar includes an outer casing, an inner casing, force sensor unit, gear and thread mechanism, and an axial motor;
a controller unit connected to said sensors and said motors, which is capable of receiving force output from said sensors and rotate said motors in any direction at desired/variable speed to adjust the height of said pillars; and
a processor unit suitably programmed to map the human body part being rested in each area of said pillars, estimate the strength of said area and apply the force proportionate to the strength/hardness in said area.
Reference for claim 1:
Para 00019: The force change due to human body weight at each pillars are monitored by the controller unit, the overlying body and its posture is visualized by the controller unit and the pillars heights are varied to form a desired top surface profile.

2. The system of claim 1, wherein said force sensor comprises of a spring, a pin, a bobbin and coils,

3. The system of claim 1, wherein diameter of said axial motor is relatively smaller and having high torque thus enabling to reduce space.

4. The system of claim 1, wherein said pillars can have plurality of cross sectional shape including triangular, square and hexagonal.

5. The system of claim 1, wherein said appliances includes mattress, bed, chair, seat, sofa, stool, hand rest, back rest, foot rest, neck rest, pillow and shoe.

6. The system of claim 1, wherein said pillars capable of moving up and down direction individually or collectively to form desired surface profile of said appliances suitable for comfortable resting the human body.

7. The system of claim 5, wherein said surface profile is varied in one or more area of said surface at predetermined interval for relieving or applying pressure on human body thus reducing fatigue in long hours resting.

8. The system of claim 1, further comprises of a flexible sheet on top of pillars that can cover the space between the pillars, allowing the pillars to be kept away from each other, thus the number of pillars is reduced significantly to reduce cost.

9. The system of claim 1, wherein said pillars are kept away from each others, wherein plurality of supporting plates surrounded on top of each said pillars, thus the number of pillars are reduced significantly to reduce cost.

10. The system of claim 1, wherein said pillar capable of moving independently in horizontal and vertical direction, wherein top end of said pillar is rounded shape.
Reference for claim 10:
Para. 00040: “Top of the pillar may be rounded for being able to create smoother profile. The size and number of pillars can vary, depending on the type of appliances”.
FIG. 01—Item 101 and FIG. 02B Item 201 shows the top surface of the post rounded.

11. The system of claim 1, wherein one or more pillars are moved down at one or more area of the human body thereby to relieve local force on human body, to allow blood flow and to provide air gap while the rest of pillars keep supporting the human body.
Reference for claim 11:
Para 00015: Yet another object is to relieve part of the area time to time and switching the relieving part all over making it comfortable and healthy for long hours.
Para. 00058: When the end user rests over this for a long time, it can choose different area at different timing and move down 1401 to relieve different area at different timings to provide the comfort and better blood flow to the resting body as illustrated in the FIGS. 14A and 14B.

12. The system of claim 1, wherein one or more pillars are moved up towards the human body to press the human body to create additional pressure thereby to push the stagnant blood in that pressure area to flow for relieving said area around.
Reference for claim 12:
Line no. 0058: Further the pillars can move up 1501 and press the human body like massaging to improve the blood flow in that muscles as illustrated in the FIGS. 15A and 15B. Item no. 1401, 1501
Line no. 0059: In an embodiment, the controller unit can command pillar 101 to move in such a way to make small variations on the top surface profile, for example, releasing the force at one area at one time, and another area at another time, for better blood flow.

13. The system of claim 1, wherein said pillars positioned to apply different force at different resting area of said human body based on strength of said human body part at said resting area.
Reference for claim 13:
Para 00018: Human body has different strength and hardness at different area of each part on the outer surface. When the human body comes in contact with the support system, the self adjusting supporting system can measure the force and estimate the strength of each small area, sharing the weight of the whole body proportionally at each small area, by providing as much pressure as it can take at each location; thereby enabling to provide the best comfort.

14. The system of claim 13, wherein small axial movement of said pillar for predefined distance enables to measure change of force, wherein inverse value of said change of force per unit distance is estimation of strength of said human body part.
Reference for claim 14:
Para 00018: Human body has different strength and hardness at different area of each part on the outer surface. When the human body comes in contact with the support system, the self adjusting supporting system can measure the force and estimate the strength of each small area, sharing the weight of the whole body proportionally at each small area, by providing as much pressure as it can take at each location; thereby enabling to provide the best comfort.
Para 00075: By sensing the force/pressure map of the whole resting surface and visualizing the body shape in a processor using a software program and guessing the human body part being rested in each small area and estimating the strength of each area and applying the force proportionate to the strength/hardness in that area.

15. The system of claim 13, wherein an end user is allowed to customize said surface profile by outlining one or more portions of said resting area thereby not to press the weak or injured part of human body.
Reference for claim 15:
Par 00066: whenever a body part of an end user is weak or injured, the surface profile is made in such a way that the injured or weak body part is not pressed hard.
Para 00069: To help in safeguard the injured part or weak part of the human body, end user can define which part of the human body part should not be pressed, and the seat intelligently considers that, and gives relief to that part by reducing the height of the pillars in that area.
Para 00073: While sleeping on mattress, by giving additional relief save the important organs; provide air gap for the nose; not press the eyes; not to press the ear or ear ring; and more possibilities.

16. The system of claim 13, wherein end user is allowed to set the time notification to make specific movement of pillar at desired resting area at pre-determined time to realize the time.
Reference for claim 16:
Para 00064: In yet another embodiment, there can be specific movements provided at a pre-determined time to make a person realize the time. For example, specific movements such as vibration can be made for a wake-up call, or reminder for a meeting.

17. The system of claim 1, wherein said rested posture of end user and timings is logged to form a predefined top profile for keeping a desired shape ready for next time use.
Reference for claim 17:
Para. 00063: In another embodiment, a pre-determined surface profile can be kept ready for the end user to help him/her to take the ergonomic posture with ease.
Para 00072: Further advantage of the present invention is that by logging the previously rested posture of end user and timings, the resting appliance can form and keep a predefined top profile to a desired shape ready for the next time use.

18. The system of claim 1, wherein said supporting system is programmed to form the top profile of pillars from current shape to another shape to force the end user to switch posture to reduce body pain and fatigue of end user.
Reference for claim 18:
Para 00062: While sleeping, many a times, a person does not change positions which results in body pain and fatigue. To overcome this, in an embodiment of the present invention, the top profile of supporting system can be programmed to be formed to another shape such that a person's body changes positions after a pre-determined time of resting in the same position.

19. The system of claim 1, wherein said surface profile is arranged to provide shape of a pillow under head resting based on posture of human body thereby the head is aligned with the rest of the body.
Reference for claim 19:
Para 00067: The use of a pillow can be mitigated as the surface profile can be arranged in a way that provides the shape of a pillow. Also, the support system makes sure that the head is aligned properly with the rest of the body.

20. The system of claim 1, wherein said surface profile of appliances is adjusted at different location and with different inclination to create desired locking posture, wherein said locking posture is forward lock posture or backward lock posture.
Reference for claim 11:
Para 00060: When the present self-adjusting support system is used on a chair and the seating surface of the chair can be made at different location and different inclination such a way that the desired posture (like forward lock posture or backward lock posture) can be created.
Para 00061: In an embodiment, if an end user desires to keep his posture in a certain position, the present system can enable the same by locking the desired surface profile.
